(19) United States
(12) Patent Application Publication
(10) Pub. No.: US 2017/0161688 A1
(43) Pub. Date: Jun. 8, 2017

(54) METHOD AND SYSTEM FOR CENTRALIZED PROCESSING OF AN EMPLOYEE BENEFIT

(71) Applicant: MASTERCARD INTERNATIONAL INCORPORATED, Purchase, NY (US)

(72) Inventor: Der Pei Wang, Scarsdale, NY (US)

(21) Appl. No.: 14/958,352

(22) Filed: Dec. 3, 2015

(51) Int. Cl. G06Q 10/10; G06Q 20/40; G06Q 20/42; G06Q 20/10

(52) U.S. Cl. CPC G06Q 10/1057; G06Q 20/102; G06Q 20/40145; G06Q 20/42; G06Q 20/409

(57) ABSTRACT

There is provided a method of centralized processing of a benefit for an employee. The method includes receiving a notification of a deposit made to an account in a financial institution, and thereafter facilitating a payment from the account to a provider of the benefit. The method is performed independently of an employer, even after the employee is no longer employed by the employer, and even if the employee changes jobs and works for a different employer. There is also provided a system that performs the method, and a storage device that includes instructions that control a processor to perform the method. Centralized processing relieves systems of the employer(s) of such responsibility, thus reducing duplication of effort, and providing for more efficient utilization of processing resources.

### BACKGROUND OF THE DISCLOSURE

1. Field of the Disclosure

The present disclosure relates to processing of an employee benefit, and more particularly, to a method and system for centralized processing of the employee benefit from an employee account, independently of an employer.

2. Description of the Related Art

The approaches described in this section are approaches that could be pursued, but not necessarily approaches that have been previously conceived or pursued. Therefore, the approaches described in this section may not be prior art to the claims in this application and are not admitted to be prior art by inclusion in this section.

An employer may offer a set of elective benefits to its employees. These benefits may include, for example, health insurance, life insurance, dental insurance, vision insurance, retirement plans, and/or savings plans. The employer may provide a payroll deduction plan as a method for an employee to pay for the benefits from predetermined benefits providers. Under the payroll deduction plan, the employer deducts the cost of the benefits from the employee's gross pay, prior to the issuance of a paycheck to the employee.

There is a significant expense for the employer to provide such benefits. Not only is there a cost of the benefits themselves, but management of the payroll deduction plan can be administratively intensive. The employer may need to hire a human resources representative or an outside consulting firm to manage relationships with benefit providers, and to answer questions from the employee.

Moreover, due to the cumbersome and administrative intensive nature of providing employee benefits through payroll deductions, many employers find it economically infeasible to provide their employees with as wide a range of benefit choices as the employees would like. To this end, employers often tend to avoid providing benefits through payroll deductions beyond health care and basic insurance needs.

Thus, it is desirable to offer benefits to the employee through an alternative process that is efficient and easy to use, while also providing the employee with flexibility and control over the process.

Also, in a system that facilitates transfers of funds, there are concerns of fraud and misrepresentations of user identities. It is desirable for such a system to minimize such concerns.

### SUMMARY OF THE DISCLOSURE

There is provided a method of centralized processing of a benefit for an employee. The method includes (a) receiving a notification of a deposit made to an account in a financial institution, (b) allocating a first portion of the deposit to a reserve balance, and a second portion of the deposit to a non-reserve balance, thus yielding allocations, (c) updating a record of the reserve balance and a record of the non-reserve balance in accordance with the allocations, (d) receiving a notification of a payment being due to a benefit provider, (e) sending, to a device that is affiliated with the financial institution, a communication that instructs the financial institution to make the payment from the account to the benefit provider, and (f) updating the record of the reserve balance to reflect the payment. The method is performed independently of an employer, even after the employee is no longer employed by the employer, and even if the employee changes jobs and works for a different employer. There is also provided a system that performs the method, and a storage device that includes instructions that control a processor to perform the method. Centralized processing relieves systems of the employer(s) of such responsibility, thus reducing duplication of effort, and providing for more efficient utilization of processing resources.

### BRIEF DESCRIPTION OF THE DRAWINGS

FIG. 1 is a block diagram of a system for centralized processing of automatic payments for employee benefits.

FIG. 2 is a block diagram of components of a program module and employee account data in the system of FIG. 1.

FIG. 3 is a flowchart of a process for managing accounting of deposits to an employee account.

FIG. 4 is a flowchart of a process for facilitating a payment for a benefit.

FIG. 5 is block diagram of a process for facilitating a payment for a non-benefit transaction.

A component or a feature that is common to more than one drawing is indicated with the same reference number in each of the drawings.

### DESCRIPTION OF THE DISCLOSURE

The present document discloses a method and system for centralized processing of automatic payments for employee benefits. An employee's paycheck from an employer is deposited to an employee account in a financial institution, e.g., a bank. A payroll service provider computer, in accordance with an authorization provided by the employee, manages a transfer of funds from the employee account to a third party benefit provider. The method and the system enable the employee to both modify his/her benefits and have payments made for those benefits independently of an employer, even after the employee is no longer employed by the employer, and even if the employee changes jobs and works for a different employer. The method and the system also provides for a card, similar to a debit card, that is linked to the employee account, and with which the employee can transact business with merchants.

As used herein, “a benefit” can include any benefit that an employer can provide to an employee. Examples include, but are not limited to, one or more of health insurance, life insurance, dental insurance, vision insurance, retirement plans, savings plans, prepaid legal services, charitable contributions, and membership dues.

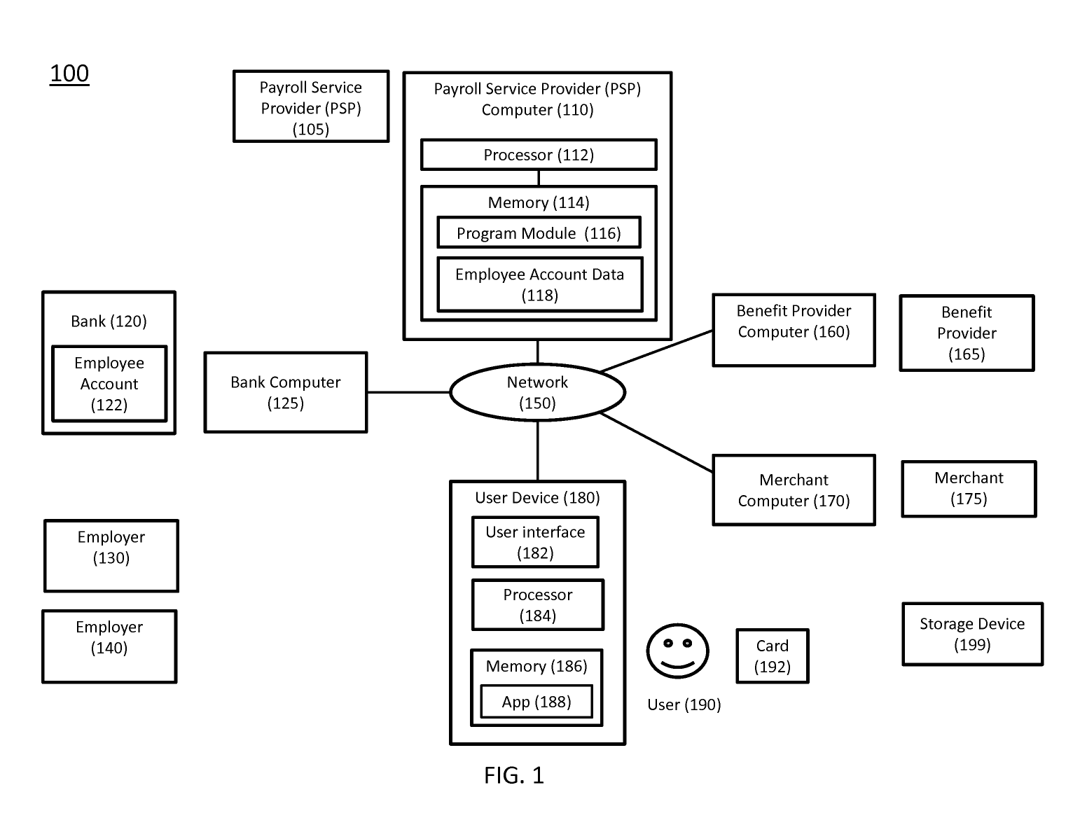

FIG. 1 is a block diagram of a system 100 for centralized processing of automatic payments for employee benefits. System 100 includes:
(a) a payroll service provider (PSP) computer 110 that is operated by, or on behalf of, a PSP 105;
(b) a bank computer 125 that is operated by, or on behalf of, a bank 120;
(c) a benefit provider computer 160 that is operated by, or on behalf of, a benefit provider 165;
(d) a merchant computer 170 that is operated by, or on behalf of, a merchant 175; and
(e) a user device 180 that is operated by, or on behalf of, a user 190.
Each of PSP computer 110, bank computer 125, benefit provider computer 160, merchant computer 170, and user device 180 is communicatively coupled to a network 150.

Network 150 is a data communications network. Network 150 may be a private network or a public network, and may include any or all of (a) a personal area network, e.g., covering a room, (b) a local area network, e.g., covering a building, (c) a campus area network, e.g., covering a campus, (d) a metropolitan area network, e.g., covering a city, (e) a wide area network, e.g., covering an area that links across metropolitan, regional, or national boundaries, or (f) the Internet. Communications are conducted over network 150 by transmitting and receiving electronic signals and optical signals.

PSP 105 administrates a payroll service program on PSP computer 110. In association with the program, PSP 105 provides representatives to manage relationships with benefit providers, and to answer questions from users of the program.

User 190 is a person, and an employee of an employer 130, and has elected to participate in a benefit, e.g., a vision insurance plan, provided by benefit provider 165, e.g., an insurance company. User 190 sets up an employee account 122 at bank 120, i.e., a financial institution, and arranges for direct deposit, into employee account 122, of compensation that user 190 earns from employer 130. This compensation includes wages, salary, and bonuses. User 190 is an owner of employee account 122.

User 190 engages PSP 105 to manage employee account 122, and authorizes PSP 105 to make a periodic withdrawal from employee account 122 for a payment to benefit provider 165. When user 190's insurance payment is due, PSP computer 110 instructs bank computer 125 to remit the payment from employee account 122 to benefit provider 165. The payment can be facilitated, for example by way of a communication between bank computer 125 and benefit provider computer 160, or by way of electronic funds transfer (EFT) via a clearing house (not shown), from employee account 122 to a financial institution (not shown) with which benefit provider 165 has an account.

With this arrangement between user 190 and PSP 105, user 190's payment to benefit provider 165 occurs independently of employer 130, and can be maintained even if user 190 terminates employment with employer 130 and takes a job with employer 140. If user 190 takes a job with employer 140, user 190 can then arrange for direct deposit, into employee account 122, of compensation that user 190 earns from employer 140.

A card 192, e.g., a debit card, is linked to employee account 122. Card 192 can be a physical card, or virtual card (e.g., a representation of a card, or an application, on user device 180). User 190 can use card 192 to pay for a product or service from merchant 175 in conjunction with a business transaction between user 190 and merchant 175. For example, during a point-of-sale transaction, user 190 presents card 192 to merchant 175 and swipes card 192 through, or otherwise presents card 192 to, a card reader (not shown) that is coupled to merchant computer 170. Merchant computer 170 engages in communications with one or both of PSP computer 110 and bank computer 125 to facilitate a payment from employee account 122 to an account of merchant 175.

PSP computer 110 includes a processor 112, and a memory 114 coupled to processor 112. Although PSP computer 110 is represented herein as a standalone device, it is not limited to such, but instead can be coupled to other devices (not shown) in a distributed processing system.

Processor 112 is an electronic device configured of logic circuitry that responds to and executes instructions.

Memory 114 is a tangible, non-transitory, computer-readable storage device encoded with a computer program. In this regard, memory 114 stores data and instructions, i.e., program code, that are readable and executable by processor 112 for controlling the operation of processor 112. Memory 114 may be implemented in a random access memory (RAM), a hard drive, a read only memory (ROM), or a combination thereof. In memory 114, there is a program module 116 and a data storage area for employee account data 118.

Employee account data 118 is a data relating to employee account 122.

Program module 116 contains instructions for controlling processor 112 to execute methods, i.e., processes and sub-processes, described herein. In the present document, when we describe operations being performed by PSP computer 110, or by a method, a process or a sub-process, the operations are actually being performed by processor 112.

The term “module” is used herein to denote a functional operation that may be embodied either as a stand-alone component or as an integrated configuration of a plurality of subordinate components. Thus, program module 116 may be implemented as a single module or as a plurality of modules that operate in cooperation with one another. Moreover, although program module 116 is described herein as being installed in memory 114, and therefore being implemented in software, it could be implemented in any of hardware (e.g., electronic circuitry), firmware, software, or a combination thereof.

While program module 116 is indicated as being already loaded into memory 114, it may be configured on a storage device 199 for subsequent loading into memory 114. Storage device 199 is a tangible, non-transitory, computer-readable storage device that stores program module 116 thereon. Examples of storage device 199 include (a) a compact disk, (b) a magnetic tape, (c) a read only memory, (d) an optical storage medium, (e) a hard drive or a memory unit consisting of multiple parallel hard drives, (f) a universal serial bus (USB) flash drive, (g) a random access memory, and (h) an electronic storage device, located on a remote storage system and coupled to PSP computer 110 via network 150.

User device 180 includes a user interface 182, a processor 184, and a memory 186 that is coupled to processor 184.

User interface 182 includes an input device, such as a keyboard, speech recognition subsystem, or gesture recognition subsystem, for enabling user 190 to communicate information to and from processor 184, and via network 150, to and from PSP computer 110. User interface 182 also includes an output device such as a display or a speech synthesizer. A cursor control or a touch-sensitive screen allows user 190 to utilize user interface 182 for communicating additional information and command selections to processor 184 and PSP computer 110.

Processor 184 is an electronic device configured of logic circuitry that responds to and executes instructions, and memory 186 is a tangible, non-transitory, computer-readable storage device that stores data and instructions, i.e., program code, that are readable and executable by processor 184, for controlling the operation of processor 184. Memory 166 includes an application (app) 188.

App 188 facilitates communication between user device 180 and PSP computer 110. In this regard, app 188 controls processor 184 to present on user interface 182 a portal to program module 116 through which user 190 can enroll in the payroll service program, authorize deductions from employee account 122 for payment of the benefit, and access information related to employee account 122. App 188 may be a special-purpose software component for invoking program module 116, or may be a general-purpose browser that allows user 190 to access a version of program module 116 implemented on a website.

Although PSP 105 and bank 120 are shown as being separate entities, in practice, they can be the same entity, or subordinates of another entity. Accordingly, if PSP 105 and bank 120 are the same entity, when user 190 engages PSP 105 to manage employee account 122, user 190 will effectively be engaging bank 120 to manage employee account 122. Thus, PSP computer 110 and bank computer 125 can be the same computer, and need not communicate with one another via network 150.

Although system 100 is shown herein as accommodating a single user, i.e., user 190, a single bank, i.e., bank 120, a single benefit provider, i.e., benefit provider 165, and a single merchant, i.e., merchant 175, system 100 can accommodate any number of users, banks, benefit providers, and merchants. Accordingly, system 100 can thus include any number of user devices, bank computers, benefit provider computers, and merchant computers.

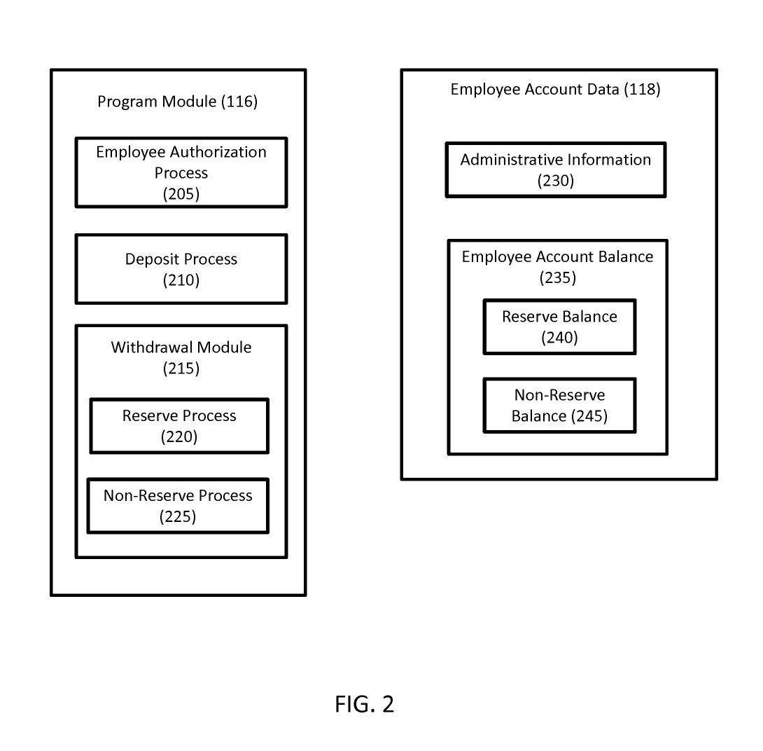

FIG. 2 is a block diagram of components of program module 116 and employee account data 118.

Employee account data 118 includes administrative information 230 and employee account balance 235.

Administrative information 230 includes information such as, names of user 190 and dependents of user 190, wage information and tax status of user 190, a name and identification of benefit provider 165, and type, amount and time of deductions for the payment of a benefit. Administrative information 230 can be organized into one or more records.

Employee account balance 235 is indicative of funds on deposit in employee account 122, and includes a reserve balance 240 and a non-reserve balance 245. Reserve balance 240 is a portion of employee account balance 235 that is reserved for the payment of benefits. Non-reserve balance 245 is a portion of employee account balance 235 available for non-benefit transactions, for example, a transaction with merchant 175. Employee account balance 235, and thus reserve balance 240 and non-reserve balance 245, can be organized into one or more records.

Program module 116 includes an employee authorization process 205, a deposit process 210, and a withdrawal module 215.

Employee authorization process 205 is invoked when user 190 utilizes app 188 to interact with PSP computer 110. Through app 188, user 190 can set up a payroll service program with PSP 105, and engage PSP 105 to manage employee account 122. After setting up employee account 122, user 190 authorizes PSP 105 to facilitate a transfer of funds from employee account 122 to benefit provider 165. User 190 can provide such authorization at the beginning of, during or after user 190's employment with employer 130. If user 190 leaves employer 130 to work for employer 140, and decides to maintain the benefit, user 190 can extend the authorization to continue during his/her employment with employer 140. User 190 can also modify an election of benefit(s). User 190 can also provide authorization for PSP 105 to automatically transfer funds from non-reserve balance 245 to reserve balance 240 for a case where reserve balance 240 is insufficient to cover a payment of a benefit, and specify schedules for automatic, periodic payments to benefit provider 165 and merchant 175.

Employee authorization process 205 employs security measures to confirm the identity of user 190. Such security measures can include (a) requiring user 190 to provide a knowledge-based identification, such as a password or personal identification number, or (b) authenticating user 190 by way of biometric authentication, which relies on a unique biological characteristic of user 190 to verify the identity of user 190. The biometric authentication can be performed, for example, by PSP computer 110 (a) sending a request to user device 180 for user 190 to utilize a detector (not shown), and (b) via the detector, reading a biological characteristic, e.g., a fingerprint, of user 190. The detector can be a part of user device 180, or a stand-alone device (not shown) that is coupled to PSP computer 110 via network 150.

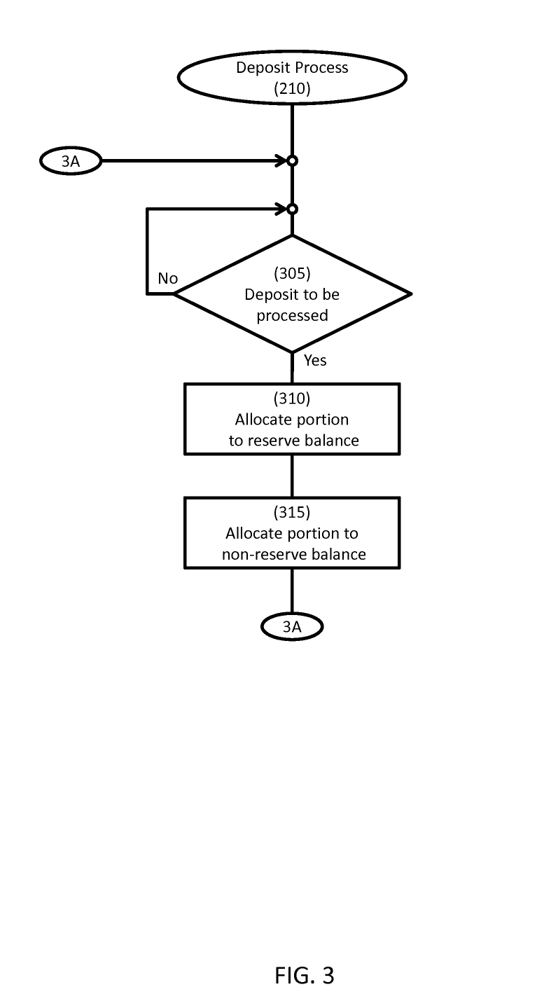

Deposit process 210 is a process for managing accounting of deposits to employee account 122. Deposit process 210 is described in greater detail below, in association with FIG. 3.

Withdrawal module 215 includes a reserve process 220 and a non-reserve process 225.

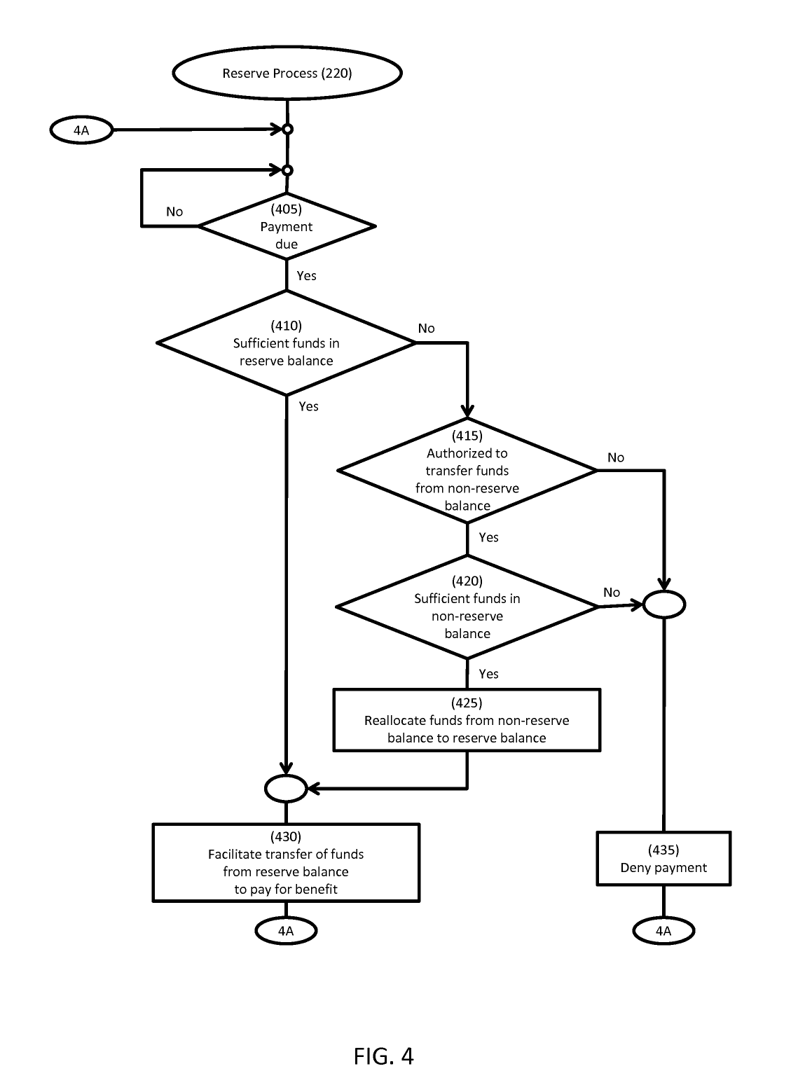

Reserve process 220 is a process for facilitating a payment for a benefit, from reserve balance 240. Reserve process 220 is described in greater detail below, in association with FIG. 4.

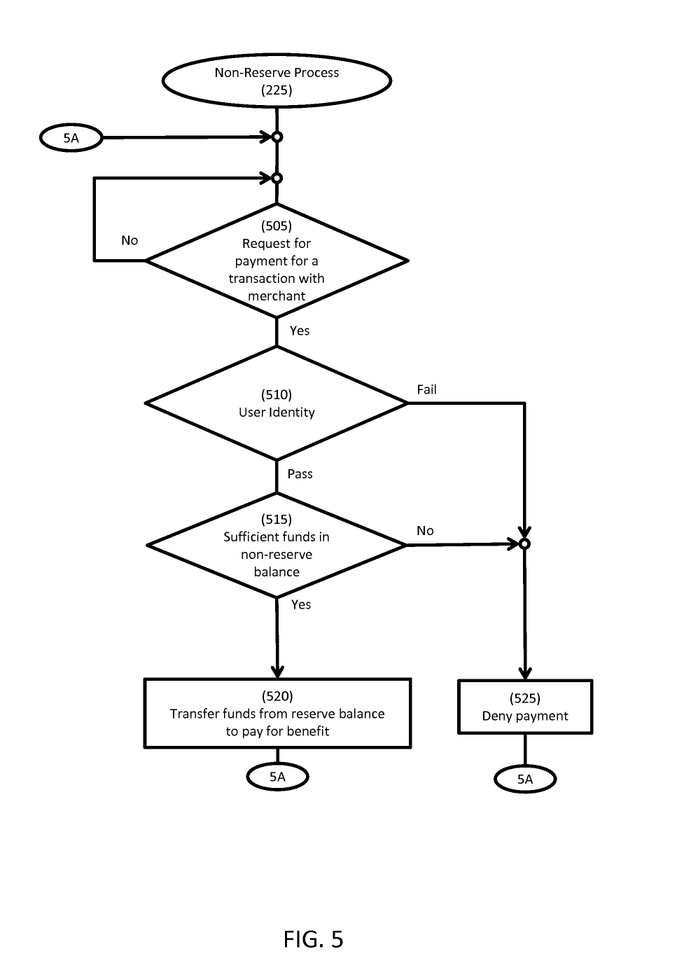

Non-reserve process 225 is a process for facilitating a payment for a non-benefit transaction, from non-reserve balance 245. Non-reserve process 225 is described in greater detail below, in association with FIG. 5.

FIG. 3 is a flowchart of deposit process 210, which, as mentioned above, is a process for managing accounting of deposits to employee account 122. Deposit process 210 commences with step 305.

In step 305, deposit process 210 checks for a deposit, to employee account 122, to be processed. Notification of a deposit, e.g., a deposit from employer 130, can be provided, for example, by a communication from bank computer 125 when a deposit is made to employee account 122. While there is no deposit to be processed, deposit process 210 remains in step 305. Upon occurrence of a deposit, deposit process 210 progresses from step 305 to step 310.

In step 310, deposit process 210 allocates a portion of the deposit to reserve balance 240, and updates reserve balance 240 accordingly. The amount of this portion depends on, and is calculated to cover, the amount that is required for the payment of benefits from employee account 122. From step 310, deposit process 210 progresses to step 315.

In step 315, deposit process 210 allocates a portion of the deposit to non-reserve balance 245, and updates non-reserve balance 245 accordingly. In practice, the portion allocated to non-reserve balance 245 will be the amount of the deposit that remains after the allocation to reserve balance 240 in step 310. From step 315, deposit process 210 loops back to step 305.

FIG. 4 is a flowchart of reserve process 220, which, as mentioned above, is a process for facilitating a payment for a benefit, from reserve balance 240. Reserve process 220 commences with step 405.

In step 405, reserve process 220 determines whether a payment is due for a benefit. This determination can be made by checking a due date or a schedule for the payment of the benefit. If no payment is due, reserve process 220 remains in step 405. If a payment is due, reserve process 220 progresses to step 410.

In step 410, reserve process 220 checks whether reserve balance 240 contains sufficient funds to pay for the benefit. If reserve balance 240 contains sufficient funds to pay for the benefit, reserve process 220 advances to step 430. If reserve balance 240 does not contain sufficient funds to pay for the benefit, i.e., reserve balance 240 has a deficiency, then reserve process 220 progresses to step 415.

In step 415, reserve process 220 inquires as to whether user 190 has authorized PSP 105 to transfer funds from non-reserve balance 245 to reserve balance 240 for a case where reserve balance 240 is insufficient to cover a payment of a benefit. If user 190 has authorized the transfer, reserve process 220 progresses to step 420. If user 190 has not authorized the transfer, reserve process 220 advances to step 435.

In step 420, reserve process 220 checks whether non-reserve balance 245 is sufficient to cover the deficiency of reserve balance 240. If non-reserve balance 245 is sufficient to cover the deficiency, reserve process 220 progresses to step 425. If non-reserve balance 245 is not sufficient to cover the deficiency, reserve process 220 advances to step 435.

In step 425, reserve process 220 reallocates funds from non-reserve balance 245 to reserve balance 240, and accordingly, updates non-reserve balance 245 and reserve balance 240. From step 425, reserve process 220 progresses to step 430.

In step 430, reserve process 220 facilitates a transfer of funds from reserve balance 240 to pay for the benefit. For example, to accomplish this, PSP computer 110 sends to bank computer 125, a communication that instructs bank 120 to send a payment from employee account 122 to benefit provider 165. As mentioned above, the payment can be made by way of EFT. Upon PSP computer 110 receiving a confirmation from either or both of bank computer 125 and benefit provider computer 160, indicating that the payment has been made, reserve process 220 updates reserve balance 240, and sends a communication to user device 180 to report a completion of the payment. After completing step 430, reserve process 220 loops back to step 405.

In step 435, reserve process 220 denies the payment. Accordingly, PSP computer 110 sends a communication to user device 180 and benefit provider computer 160, indicating that the payment has been denied. From step 435, reserve process 220 loops back to step 405.

FIG. 5 is block diagram of non-reserve process 225, which, as mentioned above, is a process for facilitating a payment for a non-benefit transaction, from non-reserve balance 245. Non-reserve process 225 commences with step 505.

In step 505, non-reserve process 225 awaits a request for a payment for a non-benefit transaction. In the present document, the non-benefit transaction will be described as being between user 190 and merchant 175, where user 190 is purchasing a product or service from merchant 175. The request can be (a) generated automatically by checking a due date or a schedule for a periodic payment to merchant 175, e.g., a monthly payment for a gym membership, or (b) received, for example, by way of a communication from merchant computer 170 to PSP computer 110 that indicates that card 192 has been presented to merchant 175 to facilitate a transaction. If there is no request, non-reserve process 225 waits in step 505. If there is a request, non-reserve process 225 progresses to step 510.

In step 510, non-reserve process 225 confirms the identity of user 190, by at least one of (a) requiring user 190 to provide a knowledge-based identification, or (b) authenticating user 190 by way of biometric authentication. The biometric authentication can be performed, for example, by PSP computer 110 (a) sending a request to user device 180 or merchant computer 170 for user 190 to utilize a detector (not shown), and (b) via the detector, reading a biological characteristic, e.g., a fingerprint, of user 190. The detector can be part of user device 180 or a stand-alone device (not shown) that is coupled to PSP computer 110 via network 150. If the identity of user 190 is confirmed, i.e., passes, then non-reserve process 225 progresses to step 515. If the identity of user 190 is not confirmed, i.e., fails, then non-reserve process 225 advances to step 525.

In step 515, non-reserve process 225 checks whether non-reserve balance 245 contains sufficient funds to pay for the transaction. If non-reserve balance 245 contains sufficient funds to pay for the transaction, then non-reserve process 225 progresses to step 520. If non-reserve balance 245 does not contain sufficient funds to pay for the transaction, then non-reserve process 225 advances to step 525.

In step 520, non-reserve process 225 facilitates a transfer of funds from non-reserve balance 245 to pay for the transaction. For example, to accomplish this, PSP computer 110 sends to bank computer 125, a communication that instructs bank 120 to send a payment from employee account 122 to merchant 175. The payment can be made by way of EFT via a clearing house (not shown). Upon PSP computer 110 receiving a confirmation from either or both of bank computer 125 and merchant computer 170, indicating that the payment has been made, non-reserve process 225 updates non-reserve balance 245, and sends a communication to user device 180 to report a completion of the payment. After completing step 520, non-reserve process 225 loops back to step 505.

In step 525, non-reserve process 225 denies the payment. Accordingly, PSP computer 110 sends a communication to each of user device 180 and merchant computer 170, indicating that the payment has been denied. From step 525, non-reserve process 225 loops back to step 505.

System 100 provides advantages such as:
(a) centralized processing of payments by PSP computer 110, which relieves systems of employers 130 and 140 of such responsibility, thus reducing duplication of effort and processing resources, and providing for more efficient utilization of processing resources;
(b) controlling timing of payments for benefits;
(c) ensuring proper authorizations and adequate funding for payments;
(d) confirming the identity of user 190 to reduce the opportunity for fraud; and
(e) safeguarding funds by operating in a virtual, i.e., electronic, environment.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof. The terms “a” and “an” are indefinite articles, and as such, do not preclude embodiments having pluralities of articles.

What is claimed is:

1. A method of centralized processing of an employee benefit, comprising:
receiving a notification of a deposit made to an account in a financial institution;
allocating a first portion of said deposit to a reserve balance, and a second portion of said deposit to a non-reserve balance, thus yielding allocations;
updating a record of said reserve balance and a record of said non-reserve balance in accordance with said allocations;
receiving a notification of a payment being due to a benefit provider;
sending, to a device that is affiliated with said financial institution, a communication that instructs said financial institution to make said payment from said account to said benefit provider; and
updating said record of said reserve balance to reflect said payment.

2. The method of claim 1, further comprising:
receiving, from a user device, a communication seeking access to information about said account; and
authenticating a user of said user device by way of biometric authentication.

3. The method of claim 1, further comprising, prior to said sending:
confirming that said reserve balance is sufficient to cover said payment.

4. The method of claim 1, further comprising, prior to said sending:
determining that said reserve balance is insufficient, by an amount of a deficiency, to cover said payment; and
reallocating funds from said non-reserve balance to said reserve balance to cover said deficiency.

5. The method of claim 4, further comprising, prior to said reallocating:
confirming that said reallocating is authorized by an owner of said account.

6. The method of claim 1, further comprising:
receiving a notification of a pending transaction involving a merchant;
sending, to said device that is affiliated with said financial institution, a communication that instructs said financial institution to make a payment from said account to said merchant; and
updating said record of said non-reserve balance to reflect said payment to said merchant.

7. The method of claim 6,
wherein said account has a card associated therewith,
wherein said notification of said pending transaction indicates that said card is being used to facilitate said pending transaction, and
wherein said method further comprises, prior to said sending:
authenticating a user of said card by way of biometric authentication.

8. A system for centralized processing of an employee benefit, comprising:
a processor; and
a memory that contains instructions that are readable by said processor to cause said processor to:
receive a notification of a deposit made to an account in a financial institution;
allocate a first portion of said deposit to a reserve balance, and a second portion of said deposit to a non-reserve balance, thus yielding allocations;
update a record of said reserve balance and a record of said non-reserve balance in accordance with said allocations;
receive a notification of a payment being due to a benefit provider;
send, to a device that is affiliated with said financial institution, a communication that instructs said financial institution to make said payment from said account to said benefit provider; and
update said record of said reserve balance to reflect said payment.

9. The system of claim 8, wherein said instructions also cause said processor to:
receive, from a user device, a communication seeking access to information about said account; and
authenticate a user of said user device by way of biometric authentication.

10. The system of claim 8, wherein said instructions, prior to causing said processor to send said communication, cause said processor to:
confirm that said reserve balance is sufficient to cover said payment.

11. The system of claim 8, wherein said instructions, prior to causing said processor to send said communication, cause said processor to:
determine that said reserve balance is insufficient, by an amount of a deficiency, to cover said payment; and
reallocate funds from said non-reserve balance to said reserve balance to cover said deficiency.

12. The system of claim 11, wherein said instructions, prior to causing said processor to reallocate funds, cause said processor to:
confirm that said reallocating is authorized by an owner of said account.

13. The system of claim 8, wherein said instructions also cause said processor to:
receive a notification of a pending transaction involving a merchant;
send, to said device that is affiliated with said financial institution, a communication that instructs said financial institution to make a payment from said account to said merchant; and
update said record of said non-reserve balance to reflect said payment to said merchant.

14. The system of claim 13,
wherein said account has a card associated therewith,
wherein said notification of said pending transaction indicates that said card is being used to facilitate said pending transaction, and
wherein said instructions, prior to causing said processor to send said communication, cause said processor to:
authenticate a user of said card by way of biometric authentication.

15. A tangible storage device comprising instructions for a processor in a system for centralized processing of an employee benefit, wherein said instructions are readable by said processor to cause said processor to:
receive a notification of a deposit made to an account in a financial institution;
allocate a first portion of said deposit to a reserve balance, and a second portion of said deposit to a non-reserve balance, thus yielding allocations;
update a record of said reserve balance and a record of said non-reserve balance in accordance with said allocations;
receive a notification of a payment being due to a benefit provider;
send, to a device that is affiliated with said financial institution, a communication that instructs said financial institution to make said payment from said account to said benefit provider; and
update said record of said reserve balance to reflect said payment.

16. The tangible storage device of claim 15, wherein said instructions also cause said processor to:
receive, from a user device, a communication seeking access to information about said account; and
authenticate a user of said user device by way of biometric authentication.

17. The tangible storage device of claim 15, wherein said instructions, prior to causing said processor to send said communication, cause said processor to:
confirm that said reserve balance is sufficient to cover said payment.

18. The tangible storage device of claim 15, wherein said instructions, prior to causing said processor to send said communication, cause said processor to:
determine that said reserve balance is insufficient, by an amount of a deficiency, to cover said payment; and
reallocate funds from said non-reserve balance to said reserve balance to cover said deficiency.

19. The tangible storage device of claim 18, wherein said instructions, prior to causing said processor to reallocate funds, cause said processor to:
confirm that said reallocating is authorized by an owner of said account.

20. The tangible storage device of claim 15, wherein said instructions also cause said processor to:
receive a notification of a pending transaction involving a merchant;
send, to said device that is affiliated with said financial institution, a communication that instructs said financial institution to make a payment from said account to said merchant; and
update said record of said non-reserve balance to reflect said payment to said merchant.

21. The tangible storage device of claim 20,
wherein said account has a card associated therewith,
wherein said notification of said pending transaction indicates that said card is being used to facilitate said pending transaction, and
wherein said instructions, prior to causing said processor to send said communication, cause said processor to:
authenticate a user of said card by way of biometric authentication.
